(19) United States
(12) Patent Application Publication
(10) Pub. No.: US 2026/0027501 A1
(43) Pub. Date: Jan. 29, 2026

(54) MULTI-STAGE FILTERING HIGH-PRESSURE COMPRESSED AIR PURIFIER

(71) Applicant: SBTEC CO., LTD., Jeonju-si (KR)

(72) Inventor: Sang Sun PARK, Iksan-si (KR)

(21) Appl. No.: 19/296,891

(22) Filed: Aug. 11, 2025

Related U.S. Application Data
(63) Continuation of application No. PCT/KR2025/008941, filed on Jun. 26, 2025.

(30) Foreign Application Priority Data
Jul. 25, 2024 (KR) 10-2024-0098510

(51) Int. Cl. B01D 46/00; B01D 53/04; B01D 53/26

(52) U.S. Cl. CPC B01D 46/0036; B01D 46/0002; B01D 53/0407; B01D 53/26; B01D 2257/702; B01D 2257/80

(57) ABSTRACT

Provided is a multi-stage filtering high-pressure compressed air purifier, and more specifically, to a multi-stage filtering high-pressure compressed air purifier having a coupling structure which can easily install and fix an oil adsorption paper through a holder mesh provided in an inner lower casing, can improve a region where air flow is not absorbed by providing an auxiliary air inlet along two directions of an inner housing, and can prevent separation due to impact between an inner housing and a base plate.

### TECHNICAL FIELD

The present invention relates to a multi-stage filtering high-pressure compressed air purifier, and more particularly, to a multi-stage filtering high-pressure compressed air purifier, which has a coupling structure capable of easily installing and fixing an oil adsorption paper through a holder mesh provided in an inner housing, improving a portion where air flow is not absorbed by providing an auxiliary air inlet along the circumferential direction of the inner housing, and preventing separation due to impact between the inner housing and a base plate.

### BACKGROUND ART

An electronic air processing unit (APU) system is basically a system for protecting pneumatic devices that will use a compressor after filtering oil, foreign substances, moisture, and the like contained in compressed air created through an air compressor, and is generally composed of an air compressor, an EAPU VALVE assembly, a ECU, an air tank, a brake chamber, a suspension bellows, a sepcooler(separation cooler), an 3Way valve, and the like, as shown in FIG. 1.

The configuration of the electronic APU system will be briefly described below.

The air compressor is configured to receive an operation signal of the EAPU and supply compressed air to the air tank through the EAPU VALVE.

The EAPU VALVE assembly is configured to receive vehicle information and intelligently control the air compressor to supply filtered air to each air tank, and to control intelligent regeneration of the filter.

In particular, a high-pressure compressed air purifier is used to filter the oil, foreign substances, and moisture of the air introduced from the air compressor into the EAPU VALVE assembly.

The ECU is a configuration for controlling an engine and an electronic unit of a vehicle.

The air tank is configured to store filtered air for the operation of a pneumatic device such as a suspension, a braking brake, a parking brake, and the like of a commercial vehicle.

The brake chamber is configured to operate a brake caliper using air pressure to generate a braking force by a disk and pad frictional force.

The suspension bellows is a configuration that relieves vertical vibration generated when driving on passengers and cargo located above the suspension.

Korean Patent Application Publication No. 10-2022-0075784 (2022.06.08) as a prior art. In the disclosure), an ‘intelligent EAPU module for commercial vehicles’ has been proposed.

However, the cartridge of the prior art has a problem in that the installation of the oil adsorption paper for oil content absorption is easy, there is a lack of air flow, and leakage is generated in the connection part requiring airtightness due to impact or the like, so that the air that is not extracted/foreign material/dehumidified is immediately supplied to the vehicle, thereby having a serious effect on the vehicle.

### DISCLOSURE

### Technical Problem

The present invention has been devised to solve the problems of the prior art as described above, and an object of the present invention is to provide a multi-stage filtering high-pressure compressed air purifier having a coupling structure capable of facilitating the installation and fixing of the oil and absorbent paper of a housing, facilitating the flow of air inside, and preventing separation due to impact.

### Technical Solution

In order to achieve the objective, a multi-stage filtering high-pressure compressed air purifier comprising: an inner housing including an accommodation space formed therein, a main air inlet formed on a top surface of an upper end portion thereof, an air outlet formed on a bottom center of a lower end portion thereof, a concave portion formed in a side surface of a lower end portion thereof so as to have an installation space formed outside the concave portion, and a cylindrical adsorption paper winding part provided in the installation space; an outer housing surrounding the inner housing from the outside and forming an air flow path through a gap spaced apart from the inner housing so that compressed air introduced from an air compressor flows toward the main air inlet through the installation space; an oil filtering means provided with an oil adsorption paper installed in the installation space to filter oil fractions of passing air; and a moisture filtering means provided with a dehumidifying agent accommodated in the accommodation space to filter moisture of passing air; wherein the oil filtering means includes a holder mesh which is formed in a cylindrical shape larger than a diameter of the adsorption paper winding part, is formed in a mesh structure capable of flowing air to the inside and the outside, and has an inner surface in surface contact with the oil adsorption paper in a state in which the oil adsorption paper is wound in a roll shape, and fixedly supports the oil adsorption paper; and wherein the inner housing has an auxiliary air inlet formed along a circumferential direction on a side surface at an upper position of the concave portion.

Here, the inner housing has insertion grooves formed in a predetermined pattern in the circumferential direction at the upper end and the lower end of the adsorption paper winding part, respectively, and the holder mesh includes a plurality of holder units having coupling protrusions inserted into the insertion grooves at the upper end and the lower end, respectively, and bent in an arc shape to form a cylindrical shape by combination.

Here, the holder mesh comprises: a flange ring in the form of a circular band made of a flexible material; and a plurality of holder units having a lower end connected in a radial continuous manner along the circumferential direction of the flange ring to enable upper ends to be spaced apart from each other, and having upper ends gathered together by an external force to form a cylindrical shape.

Here, the holder mesh further comprises a plurality of space securing ribs protruding at a predetermined interval along the circumferential direction on the outer surface thereof so as to secure the air flow path and supported in contact with the inner surface of the outer housing.

In addition, the multi-stage filtering high-pressure compressed air purifier according to the present invention further comprising: a base plate coupled to the inner housing and the outer housing while maintaining airtightness, having an air outlet communicating with the air outlet at the center thereof, and having a plurality of air inlets communicating with the air flow path along the circumferential direction to the outside of the outlet.

Here, the inner housing comprises a plate coupling part coupled to the base plate at a lower portion thereof, and the plate coupling part comprises: a tension support having a predetermined length at a position corresponding to the air inlet of the base plate and protruding from a lower portion of the inner housing to be inserted into the air inlet;
and a fixing hook formed at a front end portion of the tension support so as to be fixed by being caught on an inner lower surface of the air inlet in a state in which the insertion of the tension support is completed.

Here, the tension support comprises a plurality of columns having a predetermined length, and the fixing hook is formed by connecting the front ends of the plurality of columns to each other.

### Advantageous Effects

The multi-stage filtering high-pressure compressed air purifier according to the present invention has the advantages of facilitating the installation and fixing of the oil adsorption paper of the housing, facilitating the flow of air inside, and preventing separation due to impact.

### DESCRIPTION OF DRAWINGS

FIG. 1 relates to a configuration diagram of a general electronic APU system.

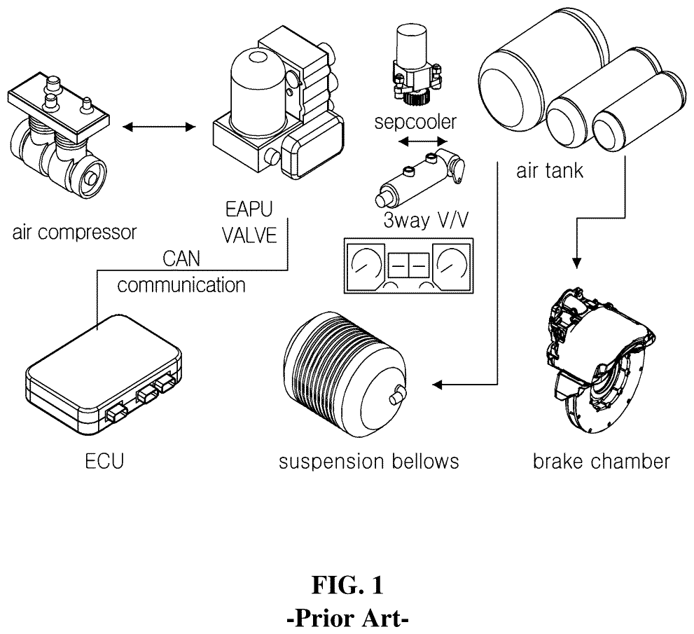

FIG. 2 relates to an exploded perspective view of a multi-stage filtering high-pressure compressed air purifier according to an embodiment of the present invention.

FIG. 3 relates to a partially cut and coupled perspective view of a multi-stage filtering high-pressure compressed air purifier according to an embodiment of the present invention.

FIG. 4 relates to an exploded partial cut-away perspective view of an inner housing according to an embodiment of the present invention.

FIG. 5 is a perspective view of a holder mesh according to an embodiment of the present invention.

FIG. 6 relates to a partial perspective view showing a cross section of a main part according to an embodiment of the present invention.

FIGS. 7A-7B relate to an air flow analysis result image of an inner housing according to the prior art.

FIGS. 8A-8B relate to the analysis result of the airflow flow of the inner housing according to the embodiment of the present invention.

FIG. 9 relates to a performance comparison graph of a high-pressure compressed air purifier and the related art according to an embodiment of the present invention.

FIGS. 10A-10B are perspective views illustrating a coupled state of a multi-stage filtering high-pressure compressed air purifier according to an embodiment of the present invention.

FIG. 11 is a cross-sectional view of main parts of a multi-stage filtering high-pressure compressed air purifier according to an embodiment of the present invention.

FIG. 12 relates to a bottom perspective view of an inner housing according to an embodiment of the present invention.

FIGS. 13A-13B are perspective views of a holder mesh according to another embodiment of the present invention.

FIGS. 14A-14B are perspective views showing the combined state of a multi-stage filtering high-pressure compressed air purifier according to another embodiment of the present invention.

### BEST MODE FOR INVENTION

A multi-stage filtering high-pressure compressed air purifier comprising: an inner housing including an accommodation space formed therein, a main air inlet formed on a top surface of an upper end portion thereof, an air outlet formed on a bottom center of a lower end portion thereof, a concave portion formed in a side surface of a lower end portion thereof so as to have an installation space formed outside the concave portion, and a cylindrical adsorption paper winding part provided in the installation space; an outer housing surrounding the inner housing from the outside and forming an air flow path through a gap spaced apart from the inner housing so that compressed air introduced from an air compressor flows toward the main air inlet through the installation space; an oil filtering means provided with an oil adsorption paper installed in the installation space to filter oil fractions of passing air;
and a moisture filtering means provided with a dehumidifying agent accommodated in the accommodation space to filter moisture of passing air; wherein the oil filtering means includes a holder mesh which is formed in a cylindrical shape larger than a diameter of the adsorption paper winding part, is formed in a mesh structure capable of flowing air to the inside and the outside, and has an inner surface in surface contact with the oil adsorption paper in a state in which the oil adsorption paper is wound in a roll shape, and fixedly supports the oil adsorption paper; and wherein the inner housing has an auxiliary air inlet formed along a circumferential direction on a side surface at an upper position of the concave portion.

### MODE FOR INVENTION

Hereinafter, a multi-stage filtering high-pressure compressed air purifier according to the present invention will be described in more detail with reference to the embodiment shown in the drawings.

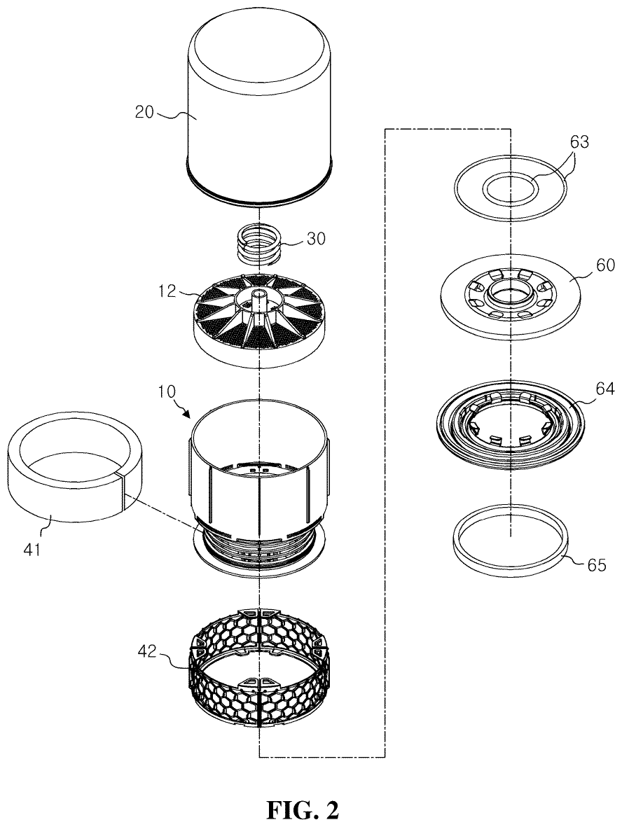

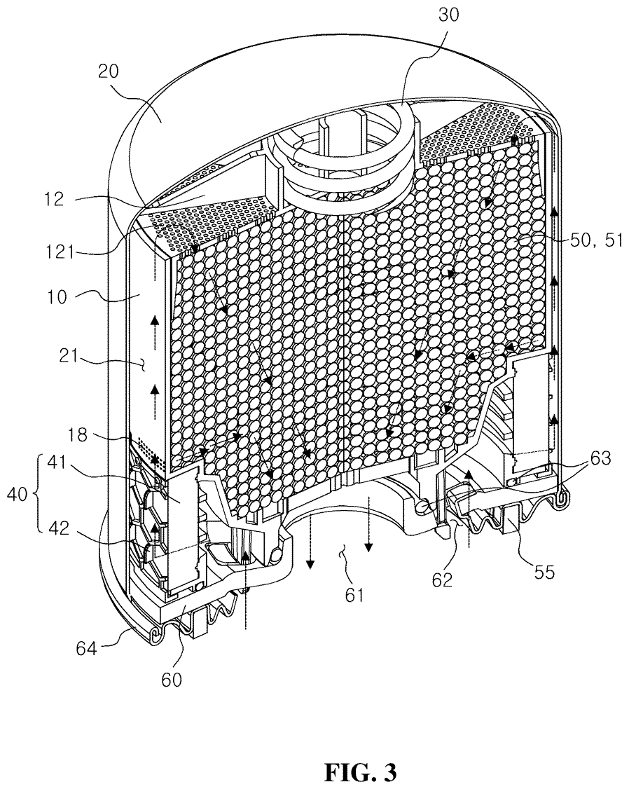

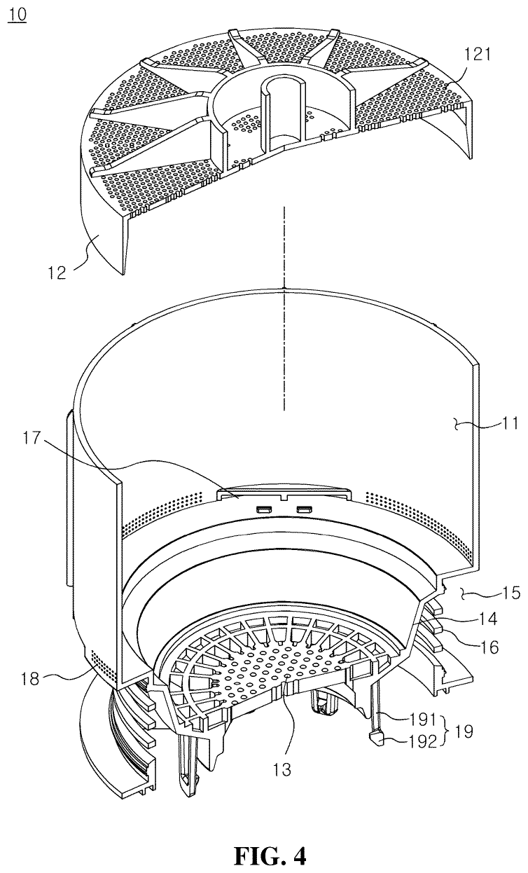

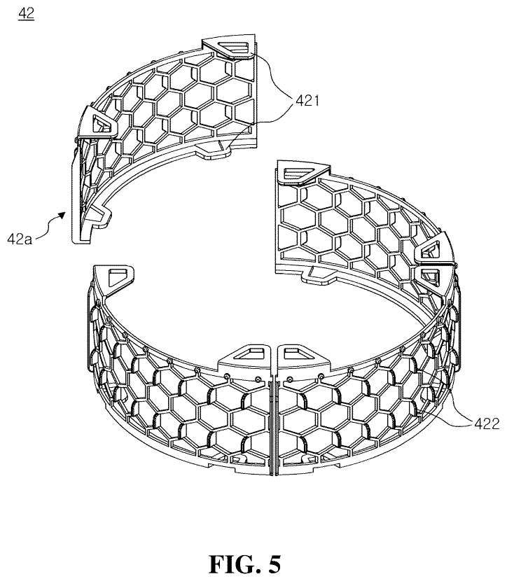

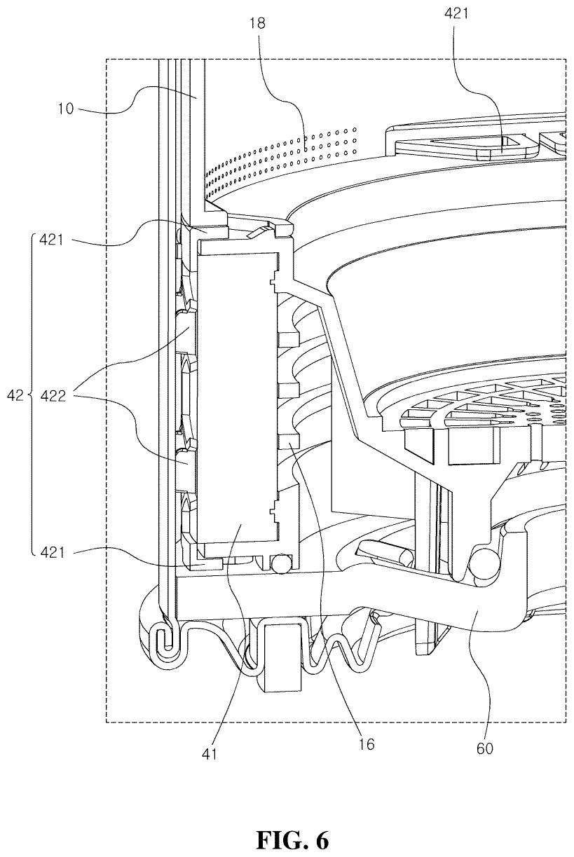

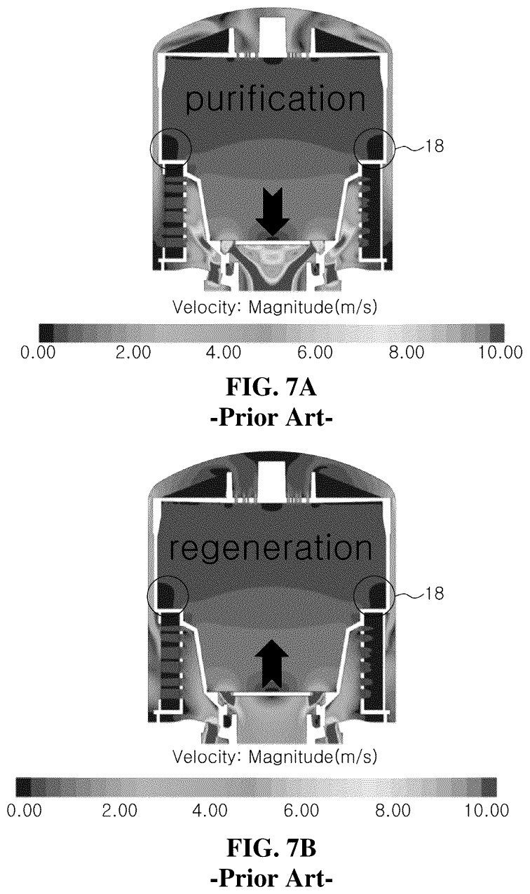

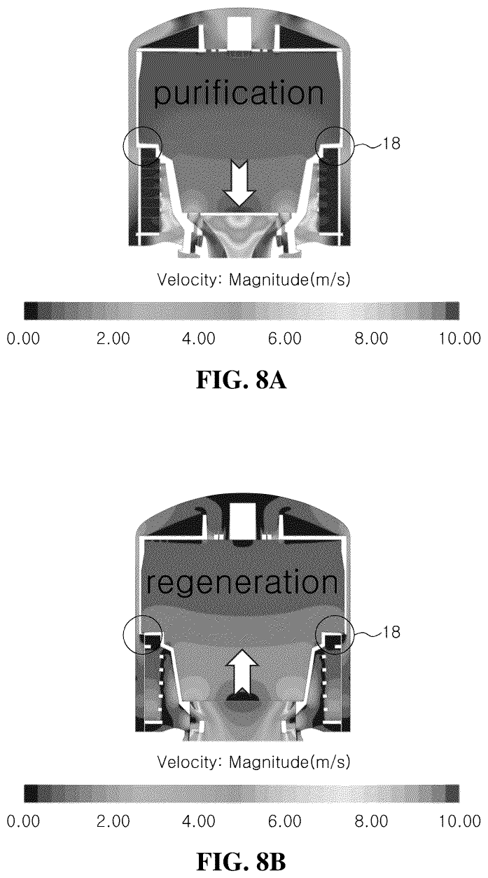

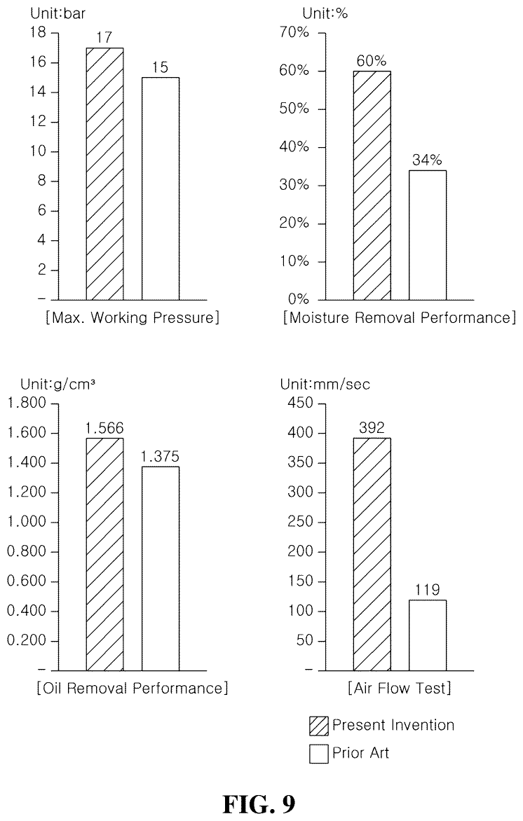

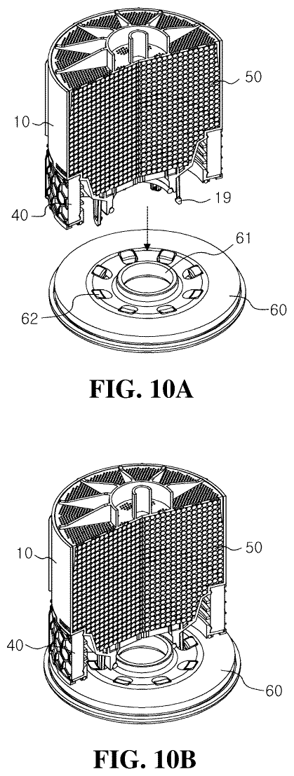

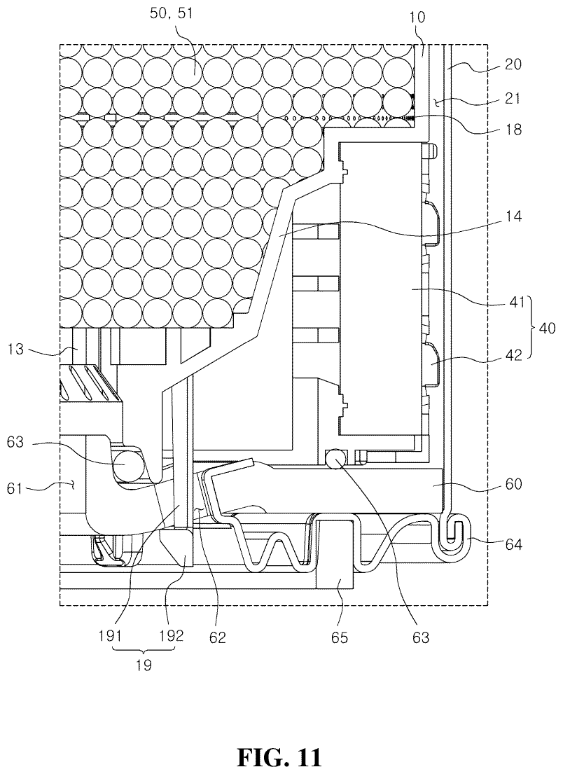

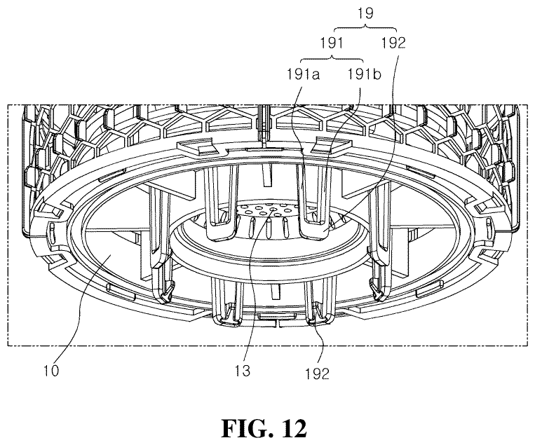

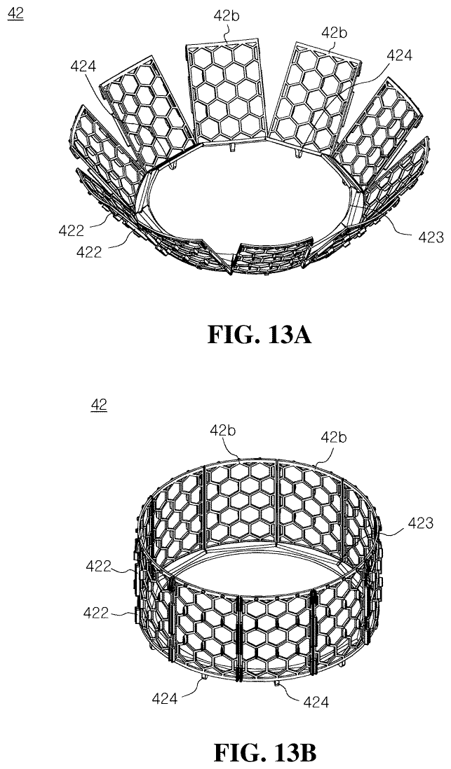

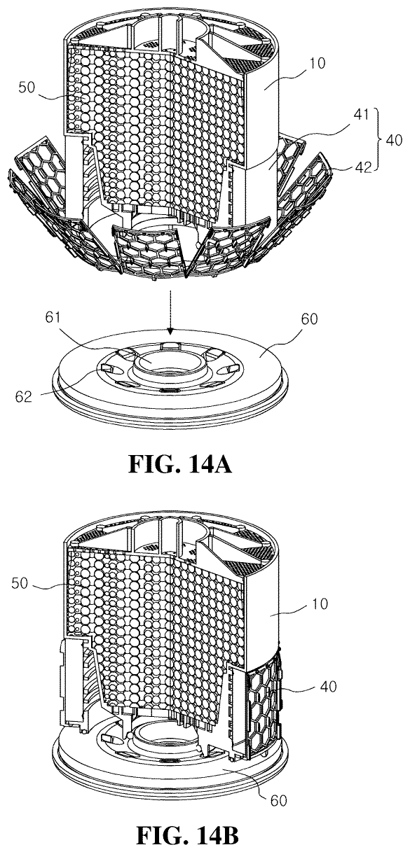

FIG. 2 is an exploded perspective view of a multi-stage filtering high-pressure compressed air purifier according to an embodiment of the present invention; FIG. 3 is a partially cut and coupled perspective view of a multi-stage filtering high-pressure compressed air purifier according to an embodiment of the present invention; FIG. 4 is an exploded partial cut-away perspective view of an inner housing according to an embodiment of the present invention; FIG. 5 is a perspective view of a holder mesh according to an embodiment of the present invention; FIG. 6 is a partial perspective view showing a cross section of a main part according to an embodiment of the present invention; FIGS. 7A-7B are air flow analysis result images of an inner housing according to the prior art; FIGS. 8A-8B are air flow analysis result images of an inner housing according to an embodiment of the present invention; FIG. 9 is a performance comparison graph of a high-pressure compressed air purifier and the related art according to an embodiment of the present invention; FIGS. 10A-10B are perspective views illustrating a coupled state of a multi-stage filtering high-pressure compressed air purifier according to an embodiment of the present invention; FIG. 11 is a cross-sectional view of main parts of a multi-stage filtering high-pressure compressed air purifier according to an embodiment of the present invention; FIG. 12 is a bottom perspective view of an inner housing according to an embodiment of the present invention; FIGS. 13A-13B are perspective views of a holder mesh according to another embodiment of the present invention; and FIGS. 14A-14B are perspective views illustrating a coupled state of a multi-stage filtering high-pressure compressed air purifier according to another embodiment of the present invention.

Referring to FIGS. 2 and 3, the multi-stage filtering high-pressure compressed air purifier according to the embodiment of the present invention includes an inner housing 10, an outer housing 20, an elastic spring 30, an oil filtering means 40, a moisture filtering means 50, and a base plate 60.

The inner housing 10 is configured to have an accommodation space 11 formed therein, a main air inlet 121 formed on the upper surface of the upper end portion, an air outlet 13 formed in the center of the lower surface of the lower end portion, a concave portion 14 recessed inward is formed on the side surface of the lower end portion, and an installation space 15 is formed outside the concave portion 14, and in an embodiment of the present invention, includes an accommodation space 11, an upper surface cap 12, an air outlet 13, a concave portion 14, an installation space 15, an adsorption paper winding part 16, an insertion groove 17, an auxiliary air inlet 18, and a plate coupling part 19.

The accommodation space 11 is a configuration formed inside the inner housing 10, and the accommodation space 11 is filled with a desiccant 51 as a moisture filtering means 50.

A porous fabric sheet (not shown), such as a nonwoven fabric, which prevents the pulverized material of the filled desiccant 51 from being introduced into the air outlet 13 formed on the bottom surface of the inner casing 10 and allows the contaminants contained in the compressed air to be filtered, may be provided on the bottom surface of the accommodation space 11.

The upper cap 12 is supported to be vertically movable on the upper portion of the accommodation space 11, has a main air inlet 121 formed on the upper surface thereof, and is elastically pressed downward by an elastic spring 30.

That is, the upper cap 12 has a main air inlet 121 formed on the upper surface thereof so that the compressed air introduced from the air compressor may flow to the accommodation space 11 through the air flow path 21, and is supported to be movable up and down, and by a combination with an elastic spring 30 to be described later, the desiccant 51 filled in the accommodation space 11 is elastically prevented in the downward direction, thereby effectively fixing the desiccant 51 even when the desiccant 51 is reduced.

Meanwhile, the main air inlet 121 communicates with the air inlet 62 of the base plate 60 via the air flow path 21.

The air outlet 13 is formed in the center of the bottom surface of the inner housing 10 to discharge the air passing through the water space 11 to the outside.

Meanwhile, the air outlet 13 communicates with the air outlet 61 of the base plate 60.

The concave portion 14 is formed inwardly on the side of the upper or lower end of the inner housing 10 to form an installation space 15 on the outside in which the oil filtering means 40 may be installed.

In one embodiment of the present invention, the recess 14 is configured to be formed in the lower end of the inner housing 10 so that the air inlet 62 of the base plate 60 can be directly communicated to the installation space 15.

That is, in an exemplary embodiment of the present invention, the compressed air provided from the air compressor is introduced into the air inlet 62 of the base plate 60, and then primarily passes through the oil filtering means 40 installed in the installation space 15.

The absorbent paper winding unit 16 is formed in a cylindrical shape so that the oil adsorption paper 41 as the oil filtering means 40 is wound and supported in a roll shape in the installation space 15.

In one embodiment of the present invention, the lower end of the absorbent paper winding part 16 is configured to contact the base plate 60 while maintaining airtightness using an O-ring 63 at an outer position of the air inlet 62 formed in the base plate 60, as shown in FIGS. 14A-14B.

With the above configuration, the compressed air introduced from the air compressor into the air let 62 of the base plate 60 is not leaked from the installation space 15, and passes through all of the oil-sucking paper 41 wound around the adsorption paper winding part 16, so that oil and foreign substances can be reliably filtered.

The fitting groove 17 is formed in a predetermined pattern along the circumferential direction at the upper end and the lower end of the adsorption paper winding part 16, respectively, so that the coupling protrusion 421 of the holder mesh 42 to be described later is fitted and coupled.

The auxiliary air inlet 18 is configured to assist the main air inlet 12 so that the compressed air introduced from the air compressor may flow between the receiving holes 11 with the air flow shown by the arrow in FIG. 3, and is formed along the circumferential direction of the inner sub-housing 10 on the upper side of the concave portion 14.

That is, when the compressed air introduced into the main air inlet 121 from the inner housing 10 passes through the receiving space 11 and then is discharged to the air outlet 13, a portion of the receiving space 11 in which the air flow is insufficient is generated, and in an embodiment of the present invention to improve the air flow problem, an auxiliary air inlet 18 is additionally formed in the main air inlet 121.

FIG. 7A shows an air flow in the filtering direction of the conventional housing in which the auxiliary air inlet 18 is not formed, and FIG. 7B shows an air flow in the regeneration direction.

Referring to FIGS. 7A-7B, in the case of the related art in which the auxiliary air inlet 18 is not formed in the inner housing 10, it can be seen that a portion with insufficient air flow is formed at an upper position of the concave portion 14 inside the accommodation space 11 of the inner housing 10.

That is, as shown in FIG. 7A, as a result of flow analysis during the purification operation, it is confirmed that a flow stagnation section (a portion with insufficient air flow) occurs in the bent portion of the middle “L”, and it is expected that the dehumidification performance will eventually decrease as this phenomenon is worsened due to flow discharge when the dehumidifying agent is administered.

In addition, even during the regeneration operation as shown in FIG. 7B, the flow stagnation section is generated in the bent portion “L” of the middle as a result of the flow analysis, and it is expected that the regeneration efficiency is deteriorated as moisture and foreign substances are fixed to the stagnation section.

FIG. 8A shows the air flow in the filtering direction of the inner housing according to the embodiment of the present invention in which the auxiliary air inlet 18 is formed, and FIG. 8B shows the air flow in the regeneration direction.

Referring to FIGS. 8A-8B, it can be seen that in the present invention, the auxiliary air inlet 1 8 is formed on the side of the upper position of the concave portion 14 to improve air flow at the corresponding portion.

That is, as shown in FIG. 8A, as a result of flow analysis during the purification operation, compared with FIG. 7A, the flow stagnation section (the area with insufficient air flow) is resolved, and the overall dehumidification performance is expected to be improved.

In addition, as shown in FIG. 8B, as a result of the flow analysis even during the regeneration operation, it is expected that the overall regeneration efficiency is improved by preventing the phenomenon of moisture and foreign substances from sticking due to the removal of the flow congestion section compared to FIG. 7B.

FIG. 9 is a graph comparing the performance of the high-pressure compressed air purifier according to an embodiment of the present invention and the related art.

Referring to FIG. 9, it can be seen that the high-pressure compressed air purifier according to the exemplary embodiment of the present invention having the auxiliary air inlet 18 stably absorbs more moisture in the same condition compared to the prior art, and maintains continuous drying performance even in a long operating environment.

Through this, the multi-stage filtering high-pressure compressed air purifier according to the present invention slows the saturation rate of the desiccant 51 accommodated in the accommodation space 11, leads to the effect of extending the filter replacement cycle, and provides better maintenance efficiency and reliability to the driver.

The plate coupling part 19 is provided at the lower portion of the inner housing 10 and coupled to the base plate 60, and is configured to have a structure coupled to the air inlet 62 of the base plate 60 so as to be coupled to the base plate 60 without additional processing.

In one embodiment of the present invention, the plate coupling part 19 includes a tension support 191 having a predetermined length at a position corresponding to the air inlet 62 of the base plate 60, protruding to the lower portion of the inner housing 10, and inserted into the air inlet 62, and a fixing hook 192 formed on the front end of the tension support 191 so as to be locked and fixed to the inner lower surface of the air inlet 62 in a state in which the insertion of the tension support 191 is completed, as shown in FIG. 11.

The plate coupling part 191 has a structure that is not separated from the inner housing 10 when the inner housing 10 and the base plate 60 are coupled to each other, thereby facilitating coupling and preventing separation at the same time, thereby preventing leakage at a portion where the O-ring 63, which is a connection portion requiring airtightness between the inner housing 10 and the base plate 60, is mounted, thereby continuously maintaining the performance of the compressed air purifier according to the present invention.

In particular, in an exemplary embodiment of the present invention, the plate coupling part 191 is configured such that the tension support 191 includes a plurality of pillars 191a and 191b having a predetermined length, and the fixing hook 192 is formed to connect the front ends of the plurality of pillars 191a and 191b to each other as shown in FIG. 12.

By the above configuration, it is possible to secure a tension section having a length in which the tension support 191 can withstand a predetermined amount of tension, and the tension support 191 is composed of a plurality of pillars 191a and 191b to distribute the applied tension, thereby preventing a phenomenon that is inevitably broken by the tension generated in the process of inserting the fixing hook 192 into the air inlet 62.

The outer housing 20 is installed to surround the inner housing 10 from the outside in a configuration forming the outer shape of the multi-stage filtering high-pressure compressed air purifier according to the present invention, and is configured to form an air flow path 21 through a gap with the inner housing 10 so that the compressed air introduced from the air compressor flows toward the main air inlet 121 through the installation space 15.

The outer housing 20 is preferably designed with a pressure resistant structure capable of holding a pressure of 17bar, and is coupled to the baseplate 60 while maintaining a lower seal with the baseplate 60 by the plate seaming cap 64 of the baseplate 60.

As described above, the elastic spring 30 is installed between the outer housing 20 and the upper surface cap 12 of the inner housing 10 to elastically press the dehumidifying agent 51 filled in the water space 11 using the upper surface cap 12.

The oil filtering unit 40 is installed in the installation space 15 to filter the oil and foreign substances of the air passing through, and in an embodiment of the present invention, includes an oil adsorption paper 41 and a holder mesh 42.

The oil adsorption paper 41 is supported on the inner surface of the holder mesh 42 and is configured to filter out the oil and foreign substances of the air passing therethrough, and in an embodiment of the present invention, the oil adsorption paper 41 is configured to be wound in a roll shape on the absorbent paper winding part 16 of the inner housing 10 to facilitate installation.

The holder mesh 42 is formed in the installation space 15 in a shape that can wrap the concave portion 14 of the inner housing 10 from the outside to fix and support the oil-absorbent paper 41.

FIG. 5 shows a perspective view of the holder mesh 42 according to an embodiment of the present invention.

As shown in FIG. 5, the holder mesh 42 according to an embodiment of the present invention is formed in a cylindrical shape larger than the diameter of the suction and landing winding part 16, is formed in a mesh structure capable of flowing air inside and outside, and is provided with a coupling protrusion 421 that is fitted into the fitting groove 17 at the upper and lower ends so that the inner surface thereof is in surface contact with the oil and absorbent paper 41 in a state in which the oil and absorbent paper is wound around the suction paper winding part 16 in a roll shape manner, and the oil and absorbent paper 41 is fixed.

In one embodiment of the present invention, the holder mesh 42 is composed of a plurality of holder units 42a curved in an arc shape to form a cylindrical shape by combination, and the coupling protrusions 421 are provided at the upper end and the lower end of both ends of the holder unit 42a, respectively, so that each holder unit 42a is easily fitted and coupled to the fitting groove 17 of the inner housing 10 through the coupling protrusions 421 having a “U” shape.

Meanwhile, in an embodiment of the present invention, the holder mesh 42 is provided with a plurality of space securing ribs 422 protruding at regular intervals along the circumferential direction on the outer surface thereof and supported in contact with the inner surface of the outer housing 20 to prevent separation of the holder mesh 42, and at the same time, the air flow path 21 is secured to facilitate air flow.

Meanwhile, FIGS. 13A-13B show perspective views of a holder mesh 42 according to another embodiment of the present invention.

In another embodiment of the present invention, as shown in FIGS. 13A-13B, the holder mesh 42 is formed in a cylindrical shape larger than the diameter of the absorbent paper winding part 16 provided in the inner housing 10, and is configured to be in surface contact with the absorbent paper 41 and to fixedly support the absorbent paper 41 in a state in which the absorbent paper 41 is wound around the absorbent paper winding part 16 in a roll shape.

In addition, the holder mesh 42 according to another embodiment of the present invention includes b flange ring 423, a plurality of holder units 42a, and a rotation protrusion 424.

The flange ring 423 is configured to support the lower ends of the plurality of holder units 42b to be rotatable in the vertical direction in the form of a circular band made of a flexible material.

A plurality of the holder units 42b are connected in a radial continuous manner along the circumferential direction of the flange ring 423 such that the upper ends thereof can be separated from each other as shown in FIGS. 13A-13B, and the upper ends thereof are combined by an external force to form a cylindrical shape.

It is important that the holder mesh 42 stably fixes the oil-sucking paper 41 in the repeated filtering and regeneration operation for the purpose of the product, and the plurality of holder units 42b may be radially disposed to have structural rigidity, and the oil-sucking paper 41 may be stably fixed by uniformly pressing the oil-sucking paper 41 from all sides.

The plurality of rotation protrusions 424 protrude downward at positions corresponding to the plurality of holder units 42b along the circumferential direction of the flange ring 423 and have curved front ends.

With the configuration of the holder mesh 42 as described above, when the inner sub-housing 10 is moved downward and is coupled to the base plate 60 as shown in FIGS. 14A-14B, the front end of the rotation protrusion 424 comes into contact with the upper surface of the base plate 60, and thus the plurality of holder units 42b are rotated in a direction in which the upper ends thereof are combined with each other with respect to the rotation protrusion 424, thereby forming a cylindrical shape.

That is, in another embodiment of the present invention, the plurality of holder units 42b are rotated in a direction capable of fixing the oil-suctioning paper 41 by interlocking with the operation of the inner housing 10 being moved in the downward direction and coupled to the vane plate 60, thereby easily installing and fixing the oil-suctioning paper 41.

The moisture filtering means 50 is configured to filter the moisture of the air that is received in the receiving space 11 and passed through.

The moisture filtering means 50 may be configured with a desiccant 51 such as zeolite filled in the receiving space 11.

The base plate 60 is configured such that the O-ring 63 and the plate seaming cap 64 are hermetically coupled to the lower portions of the inner housing 10 and the outer housing 20, respectively, an air outlet 61 communicating with the air outlet 13 is formed at the center thereof, a plurality of outlets 62 communicating with the air flow path 21 along the circumferential direction to the outside of the air outlet 61 are formed, and a gasket 65 is provided on the bottom surface of the plate seaming cap 64.

The base plate 60 is generally used in a multi-stage filtering high-pressure compressed air purifier, but in the present invention, as described above, the flat coupling portion 60 of the inner housing 10 is configured to be coupled to the air inlet 62, so that the inner housing 10 may be coupled so as not to be separated by impact without performing separate processing on the base plate 60, thereby preventing leakage at the portion where the O-ring 63, which is a connection portion for requiring airtightness between the inner housing 10 and the base plate, is mounted, thereby continuously maintaining the performance of the multi-stage filtering high-pressure compressed air purifier according to the present invention.

The multi-stage filtering high-pressure compressed air purifier described above and shown in the drawings is merely one embodiment for carrying out the present invention, and should not be construed as limiting the technical spirit of the present invention. The scope of protection of the present invention is determined only by the matters described in the following claims, and it will be said that the improved and changed embodiments without departing from the gist of the present invention belong to the scope of protection of the present invention as long as it is obvious to those skilled in the art to which the present invention belongs.

### DESCRIPTION OF THE SIGN

10 inner housing
11 accommodation space
12 upper cap
13 air outlet
14 concave portion
15 installation space
16 adsorption paper winding part
17 fitting groove
18 auxiliary air inlet
19 plate coupling part
191 tension support
192 fixing hook
20 outer housing
21 air flow path
30 elastic spring
40 oil filtering means
41 oil adsorption paper
42 holder mesh
42a and 42b plurality of holder units
421 coupling projection
422 space securing rib
423 flange ring
424 rotary protrusion
50 moisture filtering means
51 desiccant
60 baseplate
61 outlet
62 air inlet

1. A multi-stage filtering high-pressure compressed air purifier comprising:
an inner housing including an accommodation space formed therein, a main air inlet disposed on a top surface of an upper end portion thereof, an air outlet disposed on a bottom center of a lower end portion thereof, a concave portion disposed in a side surface of a lower end portion thereof so as to have an installation space formed outside the concave portion, and a cylindrical adsorption paper winding part provided in the installation space;
an outer housing surrounding the inner housing and including an air flow path having a gap spacing apart from the inner housing so that compressed air introduced from an air compressor flows toward the main air inlet through the installation space;
an oil filtering means including an oil adsorption paper installed in the installation space to filter oil fractions of passing air; and
a moisture filtering means including a dehumidifying agent accommodated in the accommodation space to filter moisture of the passing air,
wherein the oil filtering means includes a holder mesh having a cylindrical shape and a diameter larger than a diameter of the adsorption paper winding part, having a mesh structure configured to flow air inside and outside, and including an inner surface in surface contact with the oil adsorption paper in a state in which the oil adsorption paper is wound in a roll shape, and fixedly supports the oil adsorption paper, and
wherein the inner housing has an auxiliary air inlet disposed along a circumferential direction on a side surface at an upper portion of the concave portion.

2. The multi-stage filtering high-pressure compressed air purifier of claim 1,
wherein the inner housing has insertion grooves disposed in a predetermined pattern and in the circumferential direction thereof at an upper end and a lower end of the adsorption paper winding part, respectively, and
the holder mesh includes a plurality of holder units, each of the plurality of holder units having coupling protrusions inserted into the insertion grooves at an upper end and a lower end thereof, and bent in an arc shape such that the plurality of holder units have a cylindrical shape by combination thereof.

3. The multi-stage filtering high-pressure compressed air purifier of claim 1,
wherein the holder mesh comprises:
a flange ring having a shape of a circular band and made of a flexible material; and
a plurality of holder units, each of the plurality of holder units having a lower end and an upper end, the lower ends being connected in a radial continuous manner along a circumferential direction of the flange ring to enable the upper ends to be spaced apart from one another, and the upper ends being arranged to form a cylindrical shape.

4. The multi-stage filtering high-pressure compressed air purifier of claim 2,
wherein the holder mesh further comprises a plurality of space securing ribs protruding at a predetermined interval along a circumferential direction thereof on an outer surface thereof so as to secure the air flow path, and
wherein the plurality of space securing ribs are in contact with an inner surface of the outer housing.

5. The multi-stage filtering high-pressure compressed air purifier of claim 1, further comprising:
a base plate coupled to the inner housing and the outer housing while maintaining airtightness, having a base plate air outlet communicating with the air outlet and disposed at a center thereof, and having a plurality of air inlets communicating with the air flow path along a circumferential direction thereof to an outside of the base plate air outlet.

6. The multi-stage filtering high-pressure compressed air purifier of claim 5,
wherein the inner housing comprises a plate coupling part coupled to the base plate at a lower portion of the inner housing, and the plate coupling part comprises: a tension support having a predetermined length, disposed at a position corresponding to the plurality of air inlets of the base plate, and protruding from a lower portion of the inner housing to be inserted into the plurality of air inlets; and
a fixing hook disposed at a front end portion of the tension support so as to be fixed on an inner lower surface of the air inlet in a state in which the insertion of the tension support is completed.

7. The multi-stage filtering high-pressure compressed air purifier of claim 6,
wherein the tension support comprises a plurality of columns having a predetermined length, and the fixing hook is configured to connect front ends of the plurality of columns to one another.
